(19) United States
(12) Patent Application Publication
(10) Pub. No.: US 2021/0090188 A1
(43) Pub. Date: Mar. 25, 2021

(54) IOT BASED PROPERTY CONDITION EVALUATION SYSTEM

(71) Applicant: International Business Machines Corporation, Armonk, NY (US)

(72) Inventors: Elaine Lai, New York, NY (US); Avery Rowe, Austin, TX (US); Susann Marie Keohane, Austin, TX (US); Cristi Nesbitt Ullmann, Austin, TX (US); Tiffany Cross, Austin, TX (US); Fang Lu, Billerica, MA (US)

(21) Appl. No.: 16/580,094

(22) Filed: Sep. 24, 2019

(51) Int. Cl. G06Q 50/16; G06Q 10/00

(52) U.S. Cl. CPC G06Q 50/163; G06Q 10/20

(57) ABSTRACT

Aspects of this disclosure relate to determining a health score of properties. For example, data from one or more sensors of each of a plurality of properties may be received from the plurality of properties. Statuses of each property of the plurality of properties may be identified from the data. A health score of a property that is within a vicinity the plurality of properties is determined using the statuses. This health score may providing to a user along with a recommended action to improve the health score.

### BACKGROUND

Many factors may be used to determine an overall health of a property. For example, the amenities of the property and the manner in which those amenities were used may impact the overall health. On top of this, surrounding properties may also reflect a health of a property. For example, a manner in which amenities of surrounding properties were utilized may indicate a likely manner in which amenities of a specific property were utilized, reflecting an overall health of the specific property.

### SUMMARY

Aspects of the present disclosure relate to a method, system, and computer program product relating to evaluating a health score of a property using an Internet of Things (IoT) based system. For example, the method includes receiving data from one or more sensors of each of a plurality of properties. The data may be received from a plurality of properties. Statuses of each property of the plurality of properties may be identified from the data. A health score of a property that is within a vicinity of the plurality of properties is determined using the statuses. The health score may be provided along with a recommended action that is determined to improve the health score. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of one embodiment of an example IoT based property health score determination system.

FIG. 2 depicts a conceptual box diagram of one embodiment of an example controller.

FIG. 3 depicts a flowchart of one embodiment of an example method of determining a health score for a property.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to evaluating properties, while more particular aspects of the present disclosure relate to gathering and analyzing data received from a plurality of Internet of Things (IoT) sensors to determine a health score of a property and provide recommendations to improve this health score. While the present disclosure is not necessarily limited to such applications, various aspects of the disclosure may be appreciated through a discussion of various examples using this context.

Aspects of this disclosure relate to systems and methods of using many streams of data, such as publicly available historical data, IoT data, or the like to determine a health score of a property such as a house. The health score of a property as used herein may reflect a general level of upkeep of the property, particularly as relating to usage of appliances of the properties (e.g., such as a furnace, air conditioning unit, or the like). One or more computing controllers that include one or more processors executing instructions stored on one or more computing memories (these computing controllers discussed generically herein as a single computing controller) may determine the evaluation of a property. The controller may improve at identifying which factors most impact the health score of a property using machine learning techniques as described herein. The controller may gather such factors as an amount of appliance usage (e.g., to determine occupancy and/or efficiency), how frequently that appliance usage changes (e.g., to determine changes in occupancy), a general usage of appliances of a property as compared to publicly available usage data (e.g., to determine if one or more properties have been over utilized), air quality readings such as radon or carbon monoxide readings of a property, emergency calls to the properties, nuisance calls or public property repairs of the property, or the like.

The controller may gather such factors and determine over time which factors indicate statues that have an impact on a property's health score. The property's health score can be used for various tasks related to a property such as, but not limited to determining a market health score of the property, determining maintenance needs for the property, determining a warranty status for the property, etc. For example, the controller may identify a status of how well maintained the properties are (as better maintenance may improve a condition of the property), a status of residents frequently turning over (as moving out may indicate a worse condition), a status of properties currently being empty (as a vacancy level over a threshold may indicate condition of the property), a status of poor thermal efficiency (which may hurt a health score), or the like. The controller may gather some or all of this data from publicly available sources and through an opt-in service from one or more residents. Using these determined statuses, the controller may determine a composite health value of the property that accounts for many factors that may be indicative of the health of the property. Based on feedback loops provided by users and/or publicly available records, the controller may determine that some statuses impact property conditions and some do not, and/or the controller may determine and/or update an extent to which these statuses impact property conditions. By using IoT data and the like for a plurality of properties to identify statuses that may impact a property health score and therein confirming and/or updating an algorithm of identifying and weighing these statuses in determining a property health score, aspects of this disclosure may improve at identifying an accurate health score or condition of properties.

The controller may send this health score to a user. The user may be the property owner. The controller may send the health score to the user so that the user may improve the health score. In some examples, the controller may identify one or more recommendations as to how to improve the health score. For example, the controller may identify appliances that may be maintained differently to improve the health score, such as by replacing a filter or executing a full cleanup or ordering a replacement part or the like. Additionally, or alternatively, the controller may recommend how different uses of the property may alter a health score. For example, the controller may specify how changing a tenancy of a property and/or a type of commercialization of a property or the like may affect a health score.

In certain examples, the controller may further autonomously execute one or more actions to improve the health score. For example, the controller may order a replacement part of cause an appliance to execute a cleaning cycle or the like. Alternatively, or additionally, the controller may schedule an appointment with a maintenance person to come in and execute a tune up or fix of one or more aspects of a property.

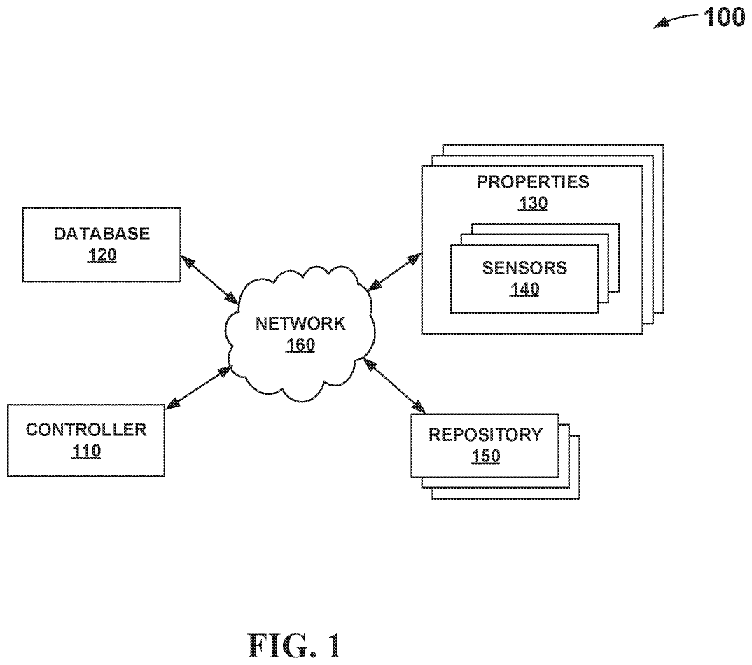

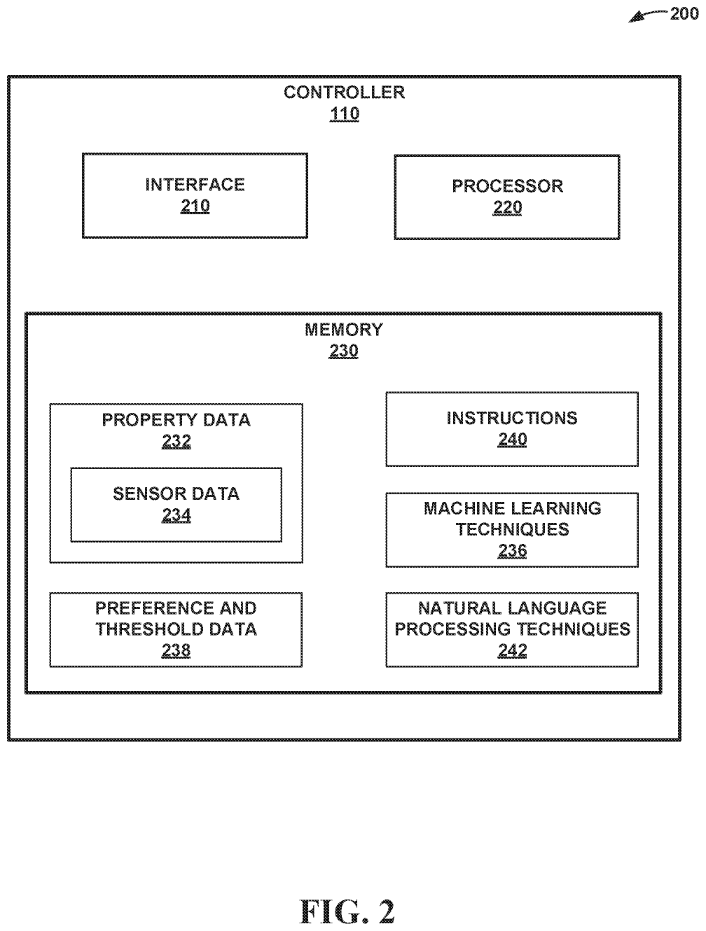

For example, FIG. 1 depicts system 100 that includes controller 110 that is configured to evaluate factors affecting a property to determine a health score for the property and provide recommendations to improve this health score. Controller 110 may include a computing device, such as computing device 200 of FIG. 2 that includes a processor communicatively coupled to a memory that includes instructions that, when executed by the processor, cause controller 110 to execute the operations described below. Controller 110 may receive requests or commands or data or the like from a user wanting a property health score determination for a property.

For example, controller 110 may receive a request to identify a property health score of a property, where the request includes a property identifier such as an address. In response to such a request, controller 110 may gather data that may impact a plurality of statuses of the property. These statuses may impact a health score of the property. The statuses may relate exclusively to the property itself, such as a thermal efficiency of the house, an amount of recent modifications and/or updates to the house, an extent to which smart appliances were well maintained, or the like. Additionally, or alternatively, the statuses may relate to the vicinity of the property, such as an amount of crime in the vicinity, and amount of natural disasters or weather-related damage in the vicinity, an amount of vacancy in the vicinity, an average length of tenancy in the vicinity, or a volume of the vicinity, or the like.

Additionally, or alternatively, controller 110 may gather data from a plurality of locations to determine these statuses. For example, once controller 110 receives the request to determine a health score of a property, controller 110 may determine the vicinity of the property. The vicinity may be defined by a distance from the property (e.g., within a mile), within a predetermined neighborhood of the property (e.g., where the city has defined neighborhoods that have generally similar types of properties within), within a city of the property, within a block of the property, or the like. Controller 110 may gather data that relates to all or some or only one other property within the vicinity.

For example, controller 110 may gather data from one or more online repositories 150 or the like that relate to properties in the vicinity. These online repositories may include weather databases (e.g., that record previous natural disasters and otherwise notable inclement weather), city maintenance databases (e.g., that record previous work done by the city to maintain infrastructure or properties), city product upgrade license databases (e.g., that record licenses granted by a city for a private party to execute an upgrade on their property), news sources (e.g., new sources that record crime statistics), or the like. In some examples, controller 110 may identify one or more appliances of a property (e.g., using data from sensors 140 as described below) and determine using repositories 150 whether or not these appliances are still under warranty. Controller 110 may crawl through one or more of these repositories 150 using natural language processing (NLP) techniques as described herein to grab data such as is described herein.

In some examples, controller 110 may determine to provide a recommendation based on warranty information. For example, in response to determining that data from sensors 140 indicate that an appliance is not working under peak efficiency and that the warranty for that appliance is about to expire, controller 110 may determine to provide a recommendation to send this appliance for warranty service while the warranty is still active. In some examples, controller 110 may determine to autonomously send in the appliance for maintenance rather than wait for an authorized user to confirm the maintenance in response to determining that there is less than a threshold amount of time (e.g., less than a week) before the warranty expires.

In some examples, controller 110 may start an evaluation from gathering historical evaluations from repositories 150 of one or more of the properties in the vicinity. Historical evaluations may include monetary values such as previous prices at which the properties were sold, tax evaluations, or the like. In some examples, if no properties within the vicinity were sold within a threshold timeframe (e.g., within the previous year or 18 months), controller 110 may identify property sales that were identified as relatively equivalent (e.g., similar square footage, number of rooms, number of bathrooms, similar age) to properties of the vicinity.

In some examples, controller 110 may gather data from a plurality of sensors 140 from properties 130 that are in the vicinity. Sensors 140 may include smart devices, such as devices that are connected to the Internet of Things (IoT). Sensors 140 may include appliances such a heating, ventilation, and cooling (HVAC) appliances, thermostats, dishwashers, fridges, televisions, speakers, doorbells, security systems, or the like.

Controller 110 may identify statuses of one or more properties in response to this data. For example, controller 110 may determine that a house has a status of being well insulated using data from sensors 140 of a thermostat, one or more HVAC appliances, and/or a security system that includes thermal images of an exterior of the house. For example, controller 110 may determine how much energy was utilized to achieve a delta between an internal temperature and an external temperature over time, or controller 110 may analyze how much heat is leaving a property using the thermal images.

Other statuses may include vacancies or other types of tenancy trends of the properties over time. For example, if one or more sensors 140 related to a respective property 130 are detected to be or have been dormant for an extended period of time (e.g., multiple months or years), controller 110 may detect that this property has been vacant for this time. In some examples, each vacant property within a vicinity may have a negative impact on other properties in the vicinity, such that multiple vacancies are worse than one.

Additionally, or alternatively, controller 110 may detect if data from sensors 140 of a respective property 130 suddenly move to a new baseline. For example, controller 110 may determine that for twelve months straight that a thermostat sensor 140 was set to 68° Fahrenheit (F) in the evenings, after which for the subsequent twelve months the thermostat sensor 140 was set to 73° F. Controller 110 may identify such changes in baseline values of sensors 140 as indicating tenancy changes, such that a previous tenant has move out and a new tenant has moved in. In some examples, controller 110 may factor in a status of high levels of tenancy turnover within a vicinity as negatively impacting a health score or condition of a property in that vicinity.

In some examples, controller 110 may further determine a number of tenants in a property using sensors 140. For example, controller 110 may use a door sensor 140 that measures how often a door is open to generally gauge a number of tenants in a property. For another example, controller 110 may utilize light sensors 140 or motion sensors 140 to determine how many rooms are currently being utilized. In some examples, the number of tenants within a property may impact a health score or condition of that property and/or neighboring properties. For example, a duplex that holds two families may be worth relatively more as a result of its relatively higher tenancy, while a house next to the duplex may be worth relatively less. Other examples are also possible.

Controller 110 may further gather information on the general manner in which appliances were used from sensors 140. For example, controller 110 may gather data from repositories 150 on how appliances are to be maintained, and controller 110 may reference data from sensors 140 to determine whether or not appliances were maintained as such (e.g., by seeing whether or not appliance sensors 140 detect that a user had to be reminded that a filter needed to be replaced or that a component was broken or the like). In some examples, where an appliance sensor 140 is providing a consistent malfunction warning, controller 110 may search repository 150 to determine a warranty status of the appliance. Where warranties of the appliances are still in effect and/or cover the malfunction warning, controller 110 may utilize this warranty to increase and/or not decrease a respective property health score. Further, where a warranty is still active, controller 110 may provide recommendations to send in a suboptimally functioning appliance for maintenance under that warranty. Controller 110 may create an aggregate appliance maintenance status of a property, increasing a health score if that property has appliances that are well maintained and decreasing the health score if the appliances were not well maintained. Further, if many properties across vicinity were poorly maintained, controller 110 may decrease a health score of all properties in the vicinity, due to a possibility of the vicinity being relatively more worn-down.

In some examples, controller 110 may use data from sensors 140 that directly indicate a status of the property, such as a carbon monoxide sensor 140 or a radon sensor 140 or the like. Where such sensors have reported such a status, controller 110 may identify this status and modify a property health score accordingly.

In some embodiments, controller 110 may determine a health score based on the health score by factoring for the statuses described herein. For example, controller 110 may determine a health score by identifying a plurality of recent sales of properties that shared most or all of the statuses of a selected property and averaging these sales out. In some examples, controller 110 may provide more weight to some statuses more than others in identifying recent sales. For example, if another property was similar in nearly every status but an age of the structure (e.g., where one property is 90 years old and the other property is 10 years old), such a sale may be lightly weighted or completely discarded. However, if another property is similar in nearly every status except for whether or not its appliances are under warranty, a price of the other property may be heavily weighted and modified slightly to take account for the warranty status.

In addition to or in lieu of determining a health score, the health score can be used to determine maintenance actions that should be performed. For example, the controller 110 can determine actions that would increase the health score of the home, such as, but not limited to, replacing/repairing a room, routine service on an HVAC system, recommended maintenance of appliances (e.g. based on manufacturer recommendations or crowdsourced data on maintenance actions regularly taken by other property owners), etc. By determining items based on the health score, the controller 110 can help improve the condition of the property including the structure and/or appliances. Additionally, in some embodiments, the controller 110 can be configured to automatically initiate the recommended actions. For example, the controller 110 can schedule a service call on the HVAC system based on the owner's calendar or cause an appliance to initiate a maintenance item (e.g. causing an oven to initiate a self-cleaning mode). Alternatively, the controller 110 can provide a prompt to a user requesting confirmation that the controller 110 initiate the recommended action.

In yet other embodiments, the health score can be used to determine a warranty status of the property. For example, the warranty may require certain actions be taken for the warranty to be valid. The health score can be used to determine if the warranty has not been voided as well as provide recommendations to avoid voiding the warranty.

Controller 110 may store some or all of this gathered data in database 120. Database 120 may be a computing device (e.g., similar to computing device 200 of FIG. 4) that is configured to store data, such as a server or a rack of servers or the like. Database 120 may store some or all data received from controller 110 in a blockchain ledger, therein showing new data or updated data as additions to the ledger, to improve a fidelity of the data used by controller 110 to determine health scores. Though database 120 is depicted as a separate device from controller 110 for the sake of illustration, in other examples database 120 may be integrated into controller 110 (e.g., similar to the depiction of FIG. 2).

Controller 110 may gather much or substantially all data that is relevant to statuses that impact health scores as described herein. In some examples, controller 110 may gather only data that is publicly available. In other examples, controller 110 may gather data in response to users opting in to having such data gathered by controller 110. For example, controller 110 may provide all residents in a neighborhood full of homes an opportunity to opt-in to having data anonymously collected for a general neighborhood health analysis. Upon receiving this opt-in from some or most or all homes, controller 110 may provide general property health scores for each home. By gathering these opt-ins to gather such data from such sensors 140 of properties 130, controller 110 may have an improved ability to provide property health scores that are more reflective of statuses, such as those that impact true health score.

In some examples, controller 110 may be configured to provide property owners information regarding how their property health scores might change in response to certain modifications to their own property and/or to the vicinity at large, as discussed above. Using such information, property owners may have an improved ability to modify their own property and/or to collectively modify a vicinity to improve property health scores. Further, by providing such potential information, controller 110 may be more likely to get opt-ins from property owners, therein improving an ability to gather data that impacts property health scores as described herein.

Controller 110 may gather this data over network 160. Network 160 may include a computing network over which computing messages and/or computing data may be sent and/or received. For example, network 160 may include the Internet, a local area network (LAN), a wide area network (WAN), a wireless network such as a wireless LAN (WLAN), or the like. Network 160 may comprise copper transmission cables, optical transmission fibers, wireless transmission, routers, firewalls, switches, gateway computers and/or edge servers. A network adapter card or network interface in each computing/processing device (e.g., controller 110, database 120, sensors 140, and/or repositories 150) may receive messages and/or instructions from and/or through network 160 and forward the messages and/or instructions for storage or execution or the like to a respective memory or processor of the respective computing/processing device.

Though network 160 is depicted as a single entity in FIG. 1 for purposes of illustration, in other examples network 160 may include a plurality of private or public networks. For example, controller 110 may store data relating to property health scores on database 120, such that controller 110 and database 120 may communicate together over a private LAN of network 160. For another example, sensors 140 of respective properties 130 may connect to controller 110 by first coupling to a private WLAN of the respective properties 130. Additionally, controller 110 may gather data related to users from repositories 150 over a public portion of network 160 using the Internet.

As described above, controller 110 may include a computing device with a processor configured to execute instructions stored on a memory to execute the techniques described herein. For example, FIG. 2 is a conceptual box diagram of such computing device 200 of controller 110. While computing device 200 is depicted as a single entity (e.g., within a single housing) for the purposes of illustration, in other examples, controller 110 may include two or more discrete physical systems (e.g., within two or more discrete housings). Controller 110 may include interfaces 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with database 120, sensors 140, repositories 150, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to determine a property health score of an identified property using data related to and from properties within a vicinity of the identified property. Controller 110 may utilize processor 220 to determine a property health score. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to determine health scores.

Processor 220 may utilize data from and of a vicinity of an identified property to determine the respective property health score according to instructions 240 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may determine health scores according to instructions 240 of one or more applications (e.g., software applications) stored in memory 230 of controller 110.

In addition to instructions 240, in some examples gathered or predetermined data or techniques or the like as used by processor 220 to determine property health scores may be stored within memory 230. For example, memory 230 may include information described above that may be stored in database 120, and/or may include substantially all of database 120. For example, as depicted in FIG. 2, memory 230 may include property data 232, which includes sensor data 234. Property data 232 and sensor data 234 may include the health scores from sensors of the properties that impact statuses of health scores, such as a vacancy or a level of upkeep as described above. Property data 232 may also include which properties have opted in to have an amount of private data collected, as well as including any publicly available data such as emergency responses to the properties or the like. Sensor data 234 may include the values gathered from these sensors, such as an amount of electricity consumed, an amount or type of output produced (e.g., hot air, cold air, alarms, volume), or the like. In some examples, some or all data of property data 232 and sensor data 234 may be stored in a blockchain ledger. By storing data in a blockchain ledger, further storing detected or determined updates to the properties as additions to this blockchain ledger, a fidelity and accuracy of property data 232 and sensor data 234 may be improved.

Memory 230 may further include machine learning techniques 236 that controller 110 may use to improve a process of determining property health scores over iterations. Machine learning techniques 236 can comprise algorithms or models that are generated by performing supervised, unsupervised, or semi-supervised training on a dataset, and subsequently applying the generated algorithm or model to generate determined health scores according to preference and threshold data 238. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Memory 230 may also include preference and threshold data 238. Preference and threshold data 238 may include data on thresholds that indicate that gathered data impacts a health score status, and further on thresholds that a status impacts a health score. Controller 110 may utilize machine learning techniques 236 to update these preferences and thresholds 238 over time. Preference and threshold data 238 may further include preferences from one or more users on determining health scores. For example, preference and threshold data 238 may include a preference to avoid factoring for some statuses (e.g., where a user does not think that a property appraisal will factor for a status, the user may instruct controller 110 to avoid accounting for that factor, even if that factor may indeed impact a fair health score of the property). For another example, preferences and threshold data 238 may include a preference for how to identify a vicinity of the property (e.g., whether a block within the property, within a mile of the property, within the city of the property, or the like).

In certain examples, preference and threshold data 238 may indicate whether or not users prefer to be notified when controller 110 determines a potential means to improve the health score of property of the users. For example, owners of multiple houses of a neighborhood may provide their addresses to controller 110, in response to which controller 110 may gather data from sensors 140 of each of these houses. Some of the homeowners may desire to only receive a current health score based on the health score, whereas other homeowners may desire to receive both a current health score and suggestions as determined by controller 110 as to how the homeowner may improve a health score. Such suggestions may include renovations, appliance updates, thermal efficiency updates, replacing windows, checking an integrity of pipes as a result of recent cold snaps that have caused burst pipes in some homes, or the like. Controller 110 may store these preferences in preference and threshold data 238, and interact with different users accordingly.

Memory 230 may include NLP techniques 242 that controller 110 may use to identify whether data stored in repositories 150 impact one or more health score statuses. NLP techniques 242 can include, but are not limited to, semantic similarity, syntactic analysis, and ontological matching. For example, in some embodiments, processor 220 may be configured to parse comments from a news source or the like in repositories 160 to determine semantic features (e.g., word meanings, repeated words, keywords, etc.) and/or syntactic features (e.g., word structure, location of semantic features in headings, title, etc.) of police reports or other types of public incidents (e.g., boorish behavior, loud atmospheres, festivals) in the vicinity that may impact health score statuses. Ontological matching could be used to map semantic and/or syntactic features to a particular concept. The concept can then be used to determine the subject matter. In this way, using NLP techniques 242, controller 110 may, e.g., identify publicly available data that impacts a health score status of one or more properties within a certain vicinity.

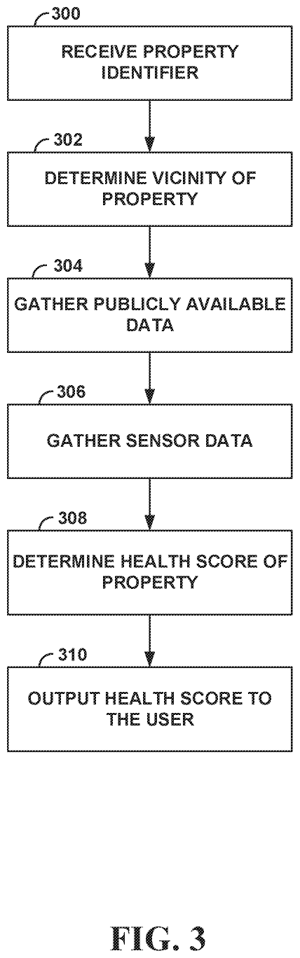

Using these components, controller 110 may determine one or more health scores of properties using data from a vicinity of the properties as discussed herein. For example, controller 110 may determine health scores according to the flowchart depicted in FIG. 3. The flowchart of FIG. 3 is discussed with relation to FIG. 1 for purposes of illustration, though it is to be understood that other systems may be used to execute the flowchart of FIG. 3 in other examples. Further, in some examples controller 110 may determine health scores differently than the flowchart of FIG. 3, or controller 110 may determine health scores via a similar method with more or less steps in a different order, or the like.

Controller 110 may receive a property identifier (300). The property identifier may include an address or a property code or a tax identifier or the like. The property identifier may be unique to the property, such that controller 110 may individually identified the property by the property identifier alone. Controller 110 may identify a vicinity of the property (302). Controller 110 may reference preference and threshold data (238 of computing device 200) to identify a vicinity of the property. Controller 110 may identify a vicinity of the property using repositories 150 (e.g., to look up the bounds of the neighborhood of the property).

Once the vicinity is identified, controller 110 may gather publicly available data (304). Controller 110 may gather both publicly available data on the identified property and also publicly available data related to other properties within the vicinity. Controller 110 may gather data from one or more repositories 150. This publicly available data may include whether emergency responders were called to anywhere in the vicinity for, e.g., fire, vandalism, theft, burglary, or the like. Such data may indicate a status of a high crime neighborhood (which hurts a health score) or a low crime neighborhood (which helps a health score). The publicly available data may also include weather data, such as incidents of flood, tornadoes, relatively large hail, or the like, any of which may indicate a status of being in an inclement weather area (which hurts a health score). An alternate form of weather data gathered by controller 110 may include recent cold weather that is substantially colder than normal temperatures of the vicinity, as such weather may indicate stressed pipes that may have partially frozen due to the pipes being ill-insulated to handle the unexpectedly cold weather).

The publicly available data may also include such things as an age of the properties (e.g., a date at which the properties were initially constructed), as older properties may indicate a status of a less up-to-date and therein potentially worse condition and/or less valuable property. Another example of publicly available data may include city permits for various forms of additions or renovations, where such additions or renovations may indicate a status of being remodeled which improves a health score e. In some examples, publicly available data may include prices of recently sold properties in the area, as prices of equivalent properties may indicate (and/or drive) the condition and/or health score of the indicated property.

Controller 110 may further gather data from one or more sensors 140 of one or more properties 130 (306). Sensors 140 may include data from smart appliances of homes, thermal data as gathered by HVAC systems, or the like. Using this sensor data, controller 110 may determine one or more statuses of the property.

For example, controller 110 may determine vacancy amounts and/or how often tenancy changes or the like by a general amount of activity from sensors 140 (e.g., where vacancy is indicated by a sudden drop to near zero from one or more sensors 140, and a tenancy change may be indicated by a sudden change of activity across a plurality of sensors 140). In some examples, controller 110 may identify volume outputs from one or more speaker sensors 140 to determine a general volume level of the vicinity at different times, where quieter vicinities may indicate relatively better health scores. Controller 110 may further use data from sensors 140 to determine whether respective properties have good thermal efficiency. For example, controller 110 may determine whether respective properties retain temperatures as compared to external temperatures over time (e.g., as overall usage may be less informative to a status than relative usage, as activating a furnace fifteen times across a certain time period to output X amount of BTUs (British Thermal Units) when there is a delta between an internal temperature and an external temperature of 100° F. may be better than activating a furnace five times over that same time period to output ¼×BTUs when the delta is 20° F.).

Using statuses determined by sensor 140 data and/or repository 150 data, controller 110 may determine a health score of the property of the property identifier (308). Controller 110 may present this health score to a user. In some examples, controller 110 may present this monetary health score along with a list of some or all detected statuses that reflect this health score. Controller 110 may provide the user with an ability to cause controller 110 to recalculate the health score without factoring for some variables (e.g., if a user thinks or knows that an appraisal will not account for those variables, and/or if the user has a temporary situation such as loud neighbors that reduce health scores that will be soon moving out). In certain examples, controller 110 may update a preference for a user and/or an aspect of the health score algorithm in response to this feedback using machine learning techniques as described herein. In some examples, controller 110 may be interfacing with a potential buy of a property, enabling this buyer to have a complete and accurate view of their property prior to ownership.

Controller 110 search for or otherwise receive a health score as determined by an external source (e.g., such as an official appraisal of the property), such that controller 110 may analyze a “correct” answer that controller 110 may use as part of a machine learning loop. For example, controller 110 may identify if a different weighting of the determined statuses would have resulted in controller 110 getting closer to this correct answer, in response to which controller 110 may update some or all aspects of its algorithm to change to this different weighting. In some examples, in response to controller 110 providing this health score to an owner of the property, the owner may make modifications to the property and/or to the neighborhood. In response to this modification, controller 110 may provide updated appraisals. In this way controller 110 may be part of a dynamic loop that learns from feedback and provides current evaluations on health scores based on many or all statuses that affect health scores of those properties.

Controller 110 may output the health score to a user (310). Controller 110 may send the health score as an email or a text message or the like sent over network 160 to a device associated with the user. Controller 110 may send the health score to a user device associated with the user that sent the property identifier (that was received at 300).

Outputting the health score may include outputting a recommended action. The recommended action may include an action that is determined by controller 110 to have a high likelihood to improve the health score of the property. For example, the recommended action may include replacing an appliance, or replacing a component (e.g., a filter) of an appliance, or cleaning or scheduling maintenance of an appliance, or the like. In some examples, controller 110 may determine that an appliance is just generally performing below expected levels, and in response to determining that a warranty is still active for this appliance as described herein controller 110 may determine to send in the appliance for maintenance under the warranty. Additionally, in some embodiments, the controller 110 may determine that maintenance is required regardless of warranty status. For example, in some such embodiments, the controller 110 can automatically schedule service for an appliance not covered under a warranty.

In certain examples, outputting the health score may include controller 110 autonomously executing one or more actions to improve the health score. For example, controller 110 may schedule an appointment for maintenance, autonomously cause an appliance to execute a maintenance action (e.g., cause an appliance to execute a clean cycle), order a physical part that is needed for maintenance, or the like.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from a plurality of properties, data from one or more sensors of each of the plurality of properties;
identifying, from the data, statuses of each property of the plurality of properties;
determining, using the statuses, a health score of a property that is within a vicinity of the plurality of properties; and
providing a recommended action that is determined to improve the health score.

2. The computer-implemented method of claim 1, wherein providing the recommended action includes generating a notification for a user to execute the recommended action.

3. The computer-implemented method of claim 1, wherein providing the recommended action includes autonomously executing the recommended action and generating a notification for a user that the recommended action is executed.

4. The computer-implemented method of claim 1, wherein the statuses include a thermal efficiency status as determined based on at least one of:
thermal sensors capturing heat leaving a property; or
a delta of a recorded environmental temperature and an internal temperature of the property.

5. The computer-implemented method of claim 1, wherein the statuses include a vacancy status.

6. The computer-implemented method of claim 1, wherein the statuses include a maintenance status.

7. The computer implemented method of claim 6, wherein the maintenance status includes determining whether a smart appliance was used according to specifications of the smart appliance.

8. The computer implemented method of claim 1, wherein the statuses include a smart appliance usage status.

9. The computer-implemented method of claim 1, wherein the sensors are connected to the Internet of Things (IoT).

10. A system comprising:
a processor; and
a memory in communication with the processor, the memory containing instructions that, when executed by the processor, cause the processor to:
receive, from a plurality of properties, data from one or more sensors of each of the plurality of properties;
identify, from the data, statuses of each property of the plurality of properties;
determine, using the statuses, a health score of a property that is within a vicinity of the plurality of properties; and
provide a recommended action that is determined to improve the health score.

11. The system of claim 10, wherein providing the recommended action includes generating a notification for a user to execute the recommended action.

12. The system of claim 10, wherein providing the recommended action includes autonomously executing the recommended action and generating a notification for a user that the recommended action is executed.

13. The system of claim 10, wherein the statuses include thermal efficiency status as determined by at least one of:
thermal sensors capturing heat leaving a property; or
a delta of a recorded environmental temperature and an internal temperature of the property.

14. The system of claim 10, wherein the statuses include a maintenance status.

15. The system of claim 14, wherein the maintenance status includes determining whether a smart appliance was used according to specifications of the smart appliance.

16. The system of claim 10, wherein the statuses include a smart appliance usage status.

17. A computer program product, the computer program product comprising a computer readable storage medium having program instructions embodied therewith, the program instructions executable by a computer to cause the computer to:
receive, from a plurality of properties, data from one or more sensors of each of the plurality of properties;
identify, from the data, statuses of each property of the plurality of properties;
determine, using the statuses, a health score of a property that is within a vicinity the plurality of properties; and
provide a recommended action that is determined to improve the health score.

18. The computer program product of claim 17, wherein providing the recommended action includes generating a notification for a user to execute the recommended action.

19. The computer program product of claim 17, wherein providing the recommended action includes autonomously executing the recommended action and generating a notification for a user that the recommended action is executed.

20. The computer program product of claim 17, wherein the statuses include at least one of:
a maintenance status that includes determining whether a smart appliance was used according to specifications of the smart appliance; or
a smart appliance usage status.
